(19) United States
(12) Patent Application Publication
(10) Pub. No.: US 2010/0243148 A1
(43) Pub. Date: Sep. 30, 2010

(54) APPARATUS AND METHOD FOR LAMINATING SOLAR MODULES

(76) Inventors: Stefan Kaufmann, Aarau (CH); Walter Gratzer, Einsiedeln (CH)

Correspondence Address: FRASER CLEMENS MARTIN & MILLER LLC, 28366 KENSINGTON LANE, PERRYSBURG, OH, 43551, US

(21) Appl. No.: 12/721,224

(22) Filed: Mar. 10, 2010

(30) Foreign Application Priority Data
Mar. 27, 2009 (EP) 09156517.6

(51) Int. Cl. B32B 38/04; B32B 37/02

(52) U.S. Cl. 156/256; 156/510; 156/353; 156/380.9

(57) ABSTRACT

An apparatus for laminating a solar module includes a form-cutting unit for form-cutting lamination foil, a holding apparatus for holding the laminating foil in a form-cutting position when form-cutting with at least one cutter, and a laying unit for laying a form-cut laminating foil piece in a laying position on a carrier plate. The apparatus further includes a cutting-off unit for cutting-off the piece of lamination foil from a foil unroller and a pull-out unit for pulling-out the lamination foil into the form-cutting position on a cutting table.

### FIELD OF THE INVENTION

This invention relates to an apparatus and a corresponding method for the so-called lamination of solar modules with this apparatus. The invention relates particularly to a production line for the form-cutting and application, or laying, of lamination foils in the manufacture of solar modules.

### BACKGROUND OF THE INVENTION

In principle, photovoltaic or solar modules are manufactured in that, on a front-side carrier plate made of, for example, glass, from its back-side, i.e. with the optically active side down, the individual solar cells and their connecting contacts (strings), or foils coated with the light-sensitive substances, are laminated with a back-side cover plate or cover foil. Immediately thereafter, or in a later work operation, the stacked layers are laminated by underpressure and heating.

Accordingly, use is made of, for example, lamination foils of EVA (ethylene vinyl acetate), PVB (polyvinyl butyral) or ionomers (thermoplastic materials as, for example, nafion), and back-side foils of tedlar (polyvinyl fluoride). These foils are supplied on stock rolls and cut to the required dimensions.

When manufacturing thick-film solar modules, in which predominant use is made of crystalline silicon, the required laying and cutting accuracy is low, because the foil that projects after the lamination can be simply cut away. In consequence, the accuracy requirements of conventional foil-cutting machines are also low.

The accuracy requirements are, however, significantly higher for the manufacture of thin-film solar modules, in which amorphous silicon, or cadmium telluride (CdTe), or copper-indium diselenide (CIS) is used. In particular with thin-film solar modules, the permanent encapsulation takes on a particular importance, since penetrating humidity and thus-caused corrosion can substantially shorten the life of the module and also impair its efficiency through undesired electrical connections of the current-carrying components. As protection against the penetration of moisture, for example the front-side carrier plate or glass plate, and the back-side lamination or cover plate (in most cases another glass plate), are sealed with an edge seal, e.g. with butyl. The lamination foil must therefore be laid with perfect fit between the sealing strips so that, on completion of lamination, no air bubbles are present, and the lamination foil does not come to rest on the sealing strips, as a result of which a reliable and long-term stable sealing would be impaired.

Depending on the application (tape or hot melt), application of the sealing strips or butyl tapes is associated with great inaccuracy (up to +/−3 mm), and the glass carrier plate also has tolerances of up to +/−1 mm. Cutting of the lamination foil and laying it onto the butyl frame are each subject to a tolerance of +/−1 mm, so that a total inaccuracy of +/−6 mm results.

Depending on the material and thickness, the lamination foil can compensate tolerances, or even an intentionally left gap, through its specific flow length and surface spreadability during the laminating operation; these material properties are, however, limited, the more so, the thinner the lamination foil. With a view to saving material and conserving resources, it is, however, desirable to use lamination foils that are as thin as possible. The cutting and laying accuracy thus takes on an even greater importance.

Conventional foil cutters, which are used for form-cutting foils for thick-film solar modules (crystalline segment), provide too little accuracy for use in the manufacture of thin-film solar modules. The conventional foil cutters from other technical areas which are used, for example, in the automobile industry for making laminated glass windows, also provide too little accuracy. A corresponding example is known from patent application EP 319 251 A2. This document describes an apparatus and a method for laminating glass. It particularly relates to placing an intermediate layer between two glass sheets, which are to be joined together by lamination. EP 0 319 251 A2 proposes working with electrostatic charge to position the intermediate layer. For the manufacture of sensitive solar modules, such a method is out of the question. In the manufacture of solar modules, electrostatic charges are consciously avoided.

Published US patent application US 2006/0219364 is concerned with feeding ceramic green compacts by means of a carrier film, form-cutting the ceramic green compacts to shape, and then laminating the form-cut green compacts. This method cannot be transferred to the lamination of solar modules, since the latter are not fed and form-cut by means of a carrier film. As an alternative, so-called plotters are used, which attain a higher cutting accuracy by means of oscillating blades. However, the laying accuracy of the form-cut lamination foil on the carrier plate remains unchanged low.

Furthermore, these systems operate with cutting mats. Since such systems form-cut a foil approximately every 30 seconds or even faster, and in 24/7 operation, the cutting mats are destroyed in a very short time by the high usage and the constantly identical geometry. Their use results in excessively high costs and machine downtimes. The alternative, of always moving the lamination foil to be form-cut by a few millimeters, and thereby better utilizing the cutting mat, also results in substantial costs on account of the consequently larger cutout of the lamination foil.

### SUMMARY OF THE INVENTION

The purpose of the present invention is to provide an apparatus, and a corresponding method that makes use of this apparatus, with which a greater accuracy can be attained, cutting is generally optimized—through, for example, in particular no cutting mats being used, less material consumption and wear occur, and thereby the costs are reduced.

The solution to the purpose consists firstly of eliminating the inaccuracy that occurs through the transfer of a holding apparatus for the lamination foil during the cutting operation to a gripper for the form-cut lamination foil during the laying operation. The apparatus according to the invention, or the method according to the invention, foresees that the holding apparatus for form-cutting is obviated in that, for laying, the gripper takes over holding of the lamination foil during cutting. This also obviates the source of inaccuracies that occur through the transfer of the lamination foil from the form-cutting process to the laying process.

Moreover, the apparatus according to the invention, or the method according to the invention, foresees a cutting operation in which cutting mats are no longer needed. For this purpose, a sub-apparatus of the total apparatus is foreseen which, by means of a pullout unit, pulls out and cuts off from the stock roll the lamination foil of a defined size and places it exactly positioned on a cutting table. This positionally accurate placement, and the dimensions of the cutting table, are chosen in such manner that the pre-cut lamination foil is laid with only a very small overlap over the edges of the cutting table. The inherent structural strength of the lamination foil, and a fixation of the lamination foil on the cutting table—for example by sucking on with a vacuum—allow such a free cut “in the air” along the edge of the cutting table, which can take place without the counterpressure of a cutting mat. The cost-intensive utilization of the cutting mats is thereby obviated and the wear of the cutting blades is appreciably reduced, since they now only cut the relatively soft lamination foil and no longer come into contact with a cutting mat that is as hard as possible. Furthermore, the positional accuracy, and the only little overlapping of the lamination foil on the cutting table, ensure a material-saving occurrence of offcut.

According to the invention, the cutting operation of the lamination foil on the cutting table is further improved in that the grippers that hold the foil—preferably a vacuum gripper—has a frame that surrounds the external contour of its supporting surface which has identical external dimensions to those of supporting surface of the cutting table. The piece of lamination foil that is to be form-cut is thus not only held by, for example, suction cups of the gripper, but in addition gripped by this frame, or pressed onto the laying surface of the cutting table from above in the area of all four external corners.

A further optimization of the cutting operation takes place through the arrangement according to the invention of four cutting blades, which process all four edges simultaneously. For this purpose, four cutting heads are arranged one on each rail of a frame. When out of operation, the four cutting heads are preferably parked in a parking position, and when in operation, travel each by means of an own drive along a respective guide rail. On completion of the cutting operation—controlled, for example, by a thrust-reversing end-switch or sensor—the cutting heads travel back into their parking position.

In this manner, optimization of the entire cutting operation, which is composed of four individual cutting operations, is attained with regard to its speed as well as its accuracy.

The cutting heads preferably execute their cutting movements simultaneously by means of a programmable control. A circuit is, however, realizable, in which the start of a first cutting head triggers the start of a second cutting head, this start in turn triggers the start of a third cutting head, and this start in turn triggers the start of a fourth cutting head.

Moreover, the cutting heads are preferably equipped with a manually actuatable spindle or a preferably electric drive to displace the cutting blade.

The cutting blades are preferably embodied as rotating circular cutting disks. However, use can also be made of translationally moved, fixed, or oscillating blades, or also of lasers.

Optionally, and to avoid possible machine downtimes, provided for the cutting blade in its parking position is a sharpening apparatus, which is combined with a further, vertically-acting displacement. That is to say, a reducing diameter of the cutting disk that is caused by operation, or also by sharpening, is readjustable until a sensor signals to the cutting head a diameter that has become excessively small.

As stated above, the lamination foil is held on the cutting table by the suction action of the cutting table, as well as by the gripper which subsequently executes laying of the cut lamination foil on the carrier plate. On the cutting table or on the gripper, further cutting blades, or lasers, or a stamping device can therefore be integrated, which exercise a rounding-off, or a further form-cutting, beyond the form of a simple square or rectangle.

There are solar modules that provide special contacting variants by means of holes or recesses that are provided for this purpose. The additional cutting blades, lasers, or stamping devices described above can optionally also be used to apply the required holes or recesses, it being possible for these devices to be arranged on the cutting table, or on the gripper, or on both.

According to a further variant embodiment, the cutting heads, and the rails along which they travel, are integrated on the side walls of the cutting table. The frame of a form-cutting unit above the cutting table, which is formed from the rails, is thus obviated, and allows free access of the gripper to the form-cut lamination foil without the cutting unit needing to be previously moved, or the lamination foil needing to be lifted out of the gripper through the frame. In this variant embodiment, the need for a parking position for the cutting heads outside the form-cut surface of the lamination foil is thus essentially and advantageously obviated.

So that in the interest of constructional simplicity in the last-mentioned variant embodiment the cutting heads cut on the side surfaces of the cutting table directly from underneath the lamination foil that is to be form-cut, the lamination foil does not, however, through the pressure of the cutting blade, raise itself, the gripper is preferably embodied in the form of a stamp, with an exactly fitting supporting surface, which thus in turn results in an edge that supports a precise cut.

The cutting table, and also the gripper, is preferably embodied in such manner that a plane surface has apertures which are filled with porous and non-slipping material. Applied to the back-side of the openings is preferably a vacuum, so that the lamination foil is sucked onto the suckers of porous material. Optionally realizable for this purpose is also a variant embodiment with classical suction cups, or also one in which the suckers or suction cups are dispensed with, and the surface of the cutting table, or of the gripper, in its entirety forms a suction bell. It must here be observed that the size of the suction bell, or the sucking-in force, does not cause excessive curvature of the lamination foil. The herewith disclosed holding variant of the lamination foil, whether with suction cups or suckers or a suction bell, can be realized not only for the cutting table, but also for the (vacuum) gripper.

Furthermore, the apparatus according to the invention has a pull-out unit that is combined with a cutting-off unit. These two units serve to grip, cut off, and pull onto the cutting table from the stock roll an adequate, subsequently to be form-cut, piece of lamination foil.

The cutting-off unit has, as has also the form-cutting unit, a preferably electrically driven cutting head which is drivable on a rail in the Y direction. The Y direction is perpendicular to the unrolling direction of the lamination foil from the stock roll. Also this cutting head of the cutting-off unit has a rotating cutting disk, or a stationery or an oscillating blade, or a laser, as a cutter. The cutting-off unit preferably has in addition a roller drive, with which an advance of the lamination foil takes place.

The cutting-off unit has, in addition, a gripping rail, which according to the invention fulfills two purposes. Firstly, by means of preferably pneumatically driven levers, the gripping rail grasps and holds the lamination foil for a clean cut. Secondly, however, the cutting-off unit, on completion of the cut, bevels the cut edge of the lamination foil upward, or also only raises it, in that—also preferably pneumatically—a push-up with an inclined end-face pushes the cutting edge of the lamination foil up from below. The inclined end-face of the push-up can be inclined at an angle of from 5 to 45 degrees, preferably, however, has an angle of 30 degrees, so that on completion of beveling, or on completion of pushing-up, an optimal transfer of the pre-cut piece of the lamination foil by grippers of the pull-out unit can take place.

Preferably, several grippers of the pull-out unit are also fastened at a corresponding angle of from 5 to 45 degrees, preferably of 30 degrees, onto a beam of the pull-out unit. The grippers are preferably pneumatically actuated and can be moved synchronously by an electric drive in the X direction by moving the beam in the longitudinal direction. Preferably, the grippers can also be moved in the plane that is formed by its angular position, i.e. along its longitudinal axis, by means of a pneumatic carriage unit. The grippers have gripper jaws which can be closed and opened preferably also pneumatically.

An alternative variant embodiment for this purpose foresees that the grippers of the pull-out unit grasp the lamination foil directly at the stock roll before cutting-off takes place. The grippers pull the lamination foil onto a cutting table of the cut edge of the previous piece of foil as far as one or more stops, end-switches, or sensors. When this—preferably settable—end-position is reached, the piece of lamination foil that is to be processed is cut off by a cutting head on the cutting table at a defined and preferably also settable distance. Hence the leading edge of the piece of foil is no longer cut first as formerly, but the trailing edge (towards the stock roll) of the piece of foil is cut immediately. This piece of foil thus comes to rest on the cutting table, and can lose any possible tension that can arise through pulling-off from the stock roll. Subsequently, the piece of lamination foil that is to be further processed is pulled onto the cutting table not by the formerly disclosed pull-out unit, but by the (vacuum) gripper, which subsequently holds the lamination foil during final form-cutting, and even later lays it on the carrier plate. Relative to the formerly disclosed variant embodiment, this variant embodiment has, firstly, the advantage that the formerly disclosed pull-out unit with inclined grippers and the beveling and pushing-up process can be obviated and less offcut occurs. Secondly, a further source of inaccuracy is also eliminated, in that additionally a further transfer less takes place, specifically that from the pull-out unit to the cutting table.

In this last-described variant embodiment, the grippers of the pull-out apparatus, which grasp directly by the stock roll, are preferably embodied as vacuum tongs which do not damage the surface of the lamination foil. In this manner it can be achieved that the cut edge of the previous piece of foil can itself be used as the definitive cut edge in the extreme X direction, so that also on this edge absolutely no more offcut occurs. The cutting table is preferably displaceable relative to an extendable stop on the new (stock roll) cut edge in the X direction towards the stock roll, so that the opposite cut edge becomes free for gripping by the vacuum tongs.

The variant embodiments that are described can also be reduced to an apparatus or a production line according to the invention in which the lamination foil is supplied in the form of pre-cut and stacked sheets. This can then be realized either in that the previously described pull-out unit pulls the uppermost sheet of lamination foil from the stack or, as described above, the (vacuum) gripper of the laying unit executes not only the holding function when form-cutting but, in addition, also executes fetching the uppermost sheet of lamination foil from the stack.

All of the disclosed variant embodiments eliminate the sources of error that result from the form-cutting itself as well as from the transfer of the lamination foil from the cutting process to the laying process. The variant embodiments that are described therefore present advantages which manifest themselves as higher processing accuracy, more efficient and material-conserving processing, and hence more accurate and less costly end-products.

However, a remaining source of error are the inaccuracies that still exist due to the application of the butyl sealing. To eliminate these also, a variant embodiment of an apparatus according to the invention is conceivable in which a high-resolution camera creates an image of the carrier plate with the applied butyl sealing. The information from this image is transmitted digitally to the control of the form-cutting unit and, before form-cutting of the lamination foil, positions the cutter exactly and according to need. Particularly cutters that cut with, for example, a laser head that is controllable in the X and Y directions would thus be able to form-cut a lamination foil which, taking into account an expansion gap, can be fitted with high precision into a butyl sealing frame of any degree of inaccuracy.

Preferably on account of a displaceability of the relevant holding apparatus and grippers, the apparatus according to the invention is suitable for laminating thin-film, as well as thick-film, solar modules.

### DESCRIPTION OF THE DRAWINGS

The invention is explained in greater detail symbolically and exemplarily by reference to figures. The figures are described interrelatedly and overall. They present diagrammatic and exemplary illustrations and are not to scale, also not with regard to the relations between the individual components. Identical reference symbols indicate identical components, reference symbols with different indices indicate functionally identical or similar components. The above as well as other advantages of the present invention will become readily apparent to those skilled in the art from the following detailed description of a preferred embodiment when considered in the light of the accompanying drawings in which:

FIG. 1 is a diagrammatic illustration of an apparatus according to the invention, or of a production line according to the invention, for form-cutting and laying lamination foil onto a carrier plate of a solar module;

FIG. 2 is a diagrammatic detail illustration of a part of the apparatus according to the invention shown in FIG. 1;

FIG. 3 is a diagrammatic detail illustration of a cutting-off unit according to the invention shown in FIG. 2;

FIG. 4 is a diagrammatic detail illustration, partially cut away, of a holding apparatus of the cutting-off unit according to the invention shown in FIG. 3;

FIG. 5 is a diagrammatic detail illustration of a pull-out unit according to the invention shown in FIG. 2;

FIG. 6 is a diagrammatic detail illustration, partially cut away, of a gripper of the pull-out unit according to the invention shown in FIG. 2;

FIG. 7 is a diagrammatic illustration of a cutting table according to the invention shown in FIG. 2;

FIG. 8 is a diagrammatic illustration of a form-cutting unit according to the invention shown in FIG. 2;

FIG. 9 is a diagrammatic detail representation of a cutting head according to the invention shown in FIG. 8;

FIG. 10 is a diagrammatic illustration of a vacuum gripper according to the invention shown in FIG. 2;

FIG. 11 is a diagrammatic detail illustration of the holding apparatus according to the invention and of the gripper according to the invention in an opened state;

FIG. 12 is a diagrammatic illustration of the holding apparatus according to the invention, and of the gripper according to the invention, in a closed state;

FIG. 13 is a diagrammatic side view of a part of the apparatus that was shown in perspective in FIG. 2, but without the vacuum gripper, and of the gripper when pulling out the lamination foil onto the cutting table;

FIG. 14 is the diagrammatic side view of FIG. 13 with the gripper in completed pull-out position;

FIG. 15 is a diagrammatic side view of the vacuum gripper in the holding position on the cutting table;

FIG. 16 is a diagrammatic and perspective illustration of the form-cutting unit while form-cutting; and

FIG. 17 is a diagrammatic side view of the laying operation of the lamination foil by means of the vacuum gripper onto the carrier plate.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

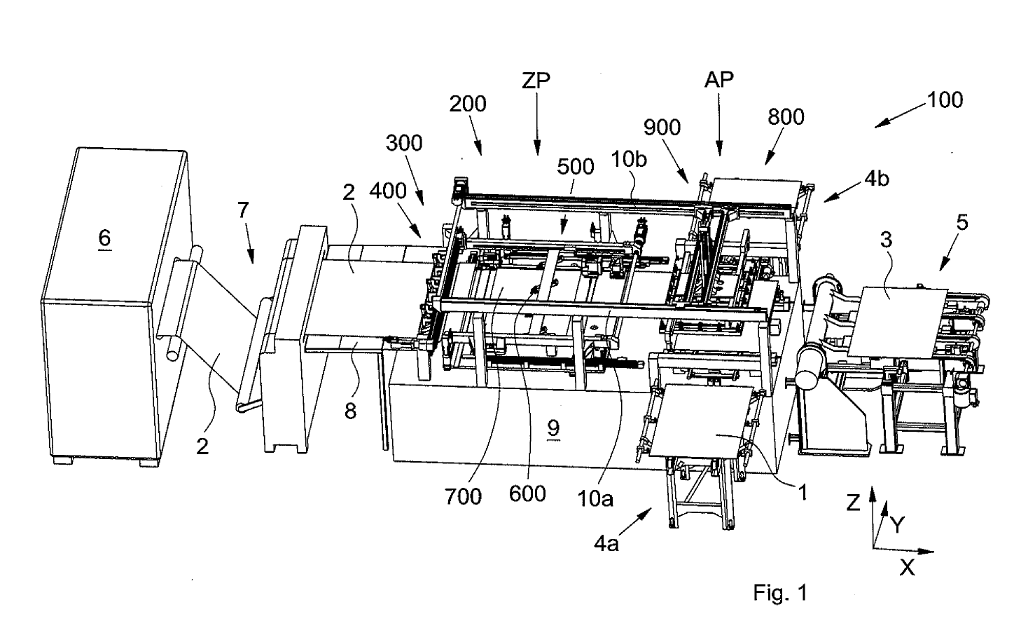

FIG. 1 shows a diagrammatic and perspective illustration of an apparatus 100 according to the invention, or of a production line 100 according to the invention, for laminating solar modules, i.e. for form-cutting and laying a lamination foil 2 onto a carrier plate 1, or onto a cover plate, which is fed by a transport system 4a of the apparatus 100. The apparatus 100 can be a closed production line, whose end-product is the laminated solar module, or be integrated in a furthergoing production line which also executes the laminating operation of the laminated solar module.

The carrier plate 1, or the cover plate, represents the optically active side of the subsequent solar module and is fed by the transport system 4a on its front-side, i.e. with its back-side facing up. Not shown here in greater detail is a sealing frame of, for example, butyl, which can be applied to the back-side of the carrier plate or to the back-side of the cover plate itself.

On completion of the form-cutting and laying operation of the lamination foil 2 onto the carrier plate 1, a cover plate 3 is laid over the latter by a turnover module 5. In the case of the application of the sealing frame onto the covering plate, the latter can be delivered by the transport system 4a, the lamination foil 2 laid thereupon, and then with the turnover module 5 the carrier plate 1 laid thereupon. The thus laminated and sealed solar module is then removed by a transport system 4b to a laminating apparatus that is not shown in more detail.

By means of a roller system 7, the lamination foil 2 is rolled off from a foil unroller 6 and comes to lie on a laying table 8. The laying table 8 is so dimensioned that a cutting-off unit 300 cuts off a sufficiently large piece of foil for subsequent processing in that a holding apparatus 400 holds the lamination foil 2 and cuts the cutting-off unit 300 in the Y direction.

A pull-out unit 500 then pulls with grippers 600 the piece of lamination foil 2 over a cutting table 700. Not only this cutting table 700, but also a form-cutting unit 200 and a vacuum gripper 800, are arranged on a base-frame 9 that has guide rails 10a and 10b. Along the latter, the vacuum gripper 800 is arranged displaceably in such manner that it can take up a form-cutting position ZP above the cutting table 700—preferably controlled with sensors or end-switches.

The lamination foil 2 that is lying on the cutting table 700 is then held both by the cutting table 700 itself and by the vacuum gripper 800 which, after reaching the horizontal position (displacement in the X direction) above the cutting table 700, is also displaceable vertically (displacement in the Z direction). The form-cutting unit 200 then form-cuts the lamination foil 2, and thereafter, according to an aspect of the present invention, the holding of the form-cut lamination foil 2 by the vacuum gripper 800 is maintained. Consequently, no further transfer to a separate laying apparatus takes place, since the vacuum gripper 800 travels with the form-cut lamination foil 2 in the X direction on the guide rails 10a and 10b into a laying position AP above the carrier plate 1 that lies ready. In the course of its processing within the apparatus 100, the lamination foil 2 thus describes a path from the form-cutting position ZP to the laying position AP in which it is held by the vacuum gripper 800.

The carrier plate 1 on the laying position AP, the feeder transport system 4a, the removal transport system 4b, and the combined usable vacuum gripper 800, form a laying unit 900.

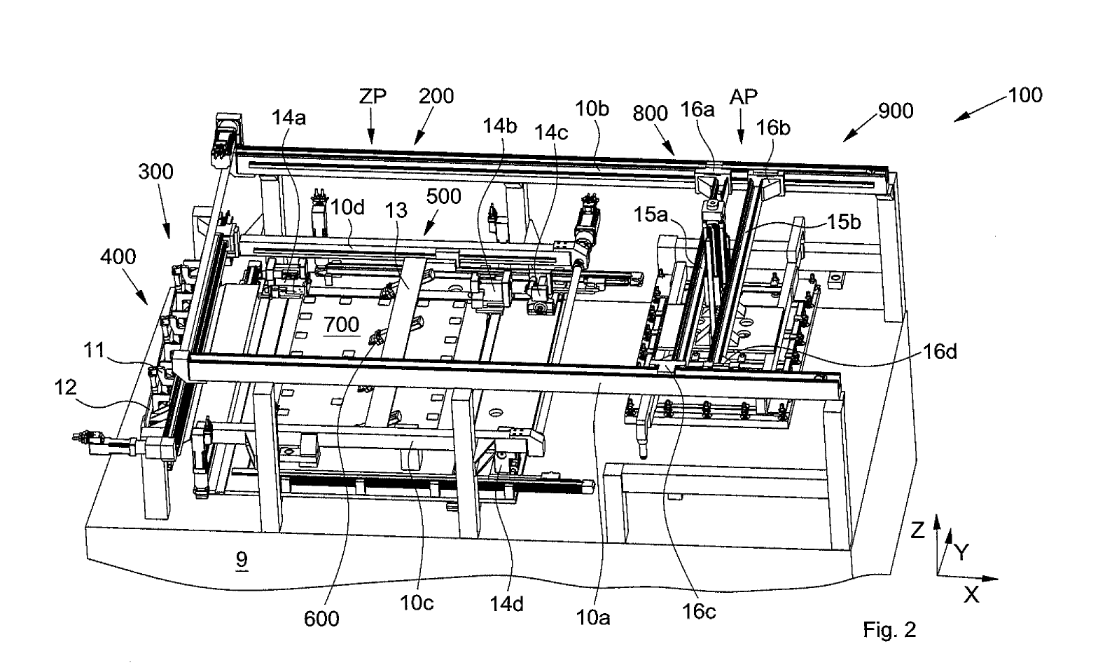

In the interest of greater clarity, FIG. 2 shows only the cutting-off unit 300, the pull-out unit 500, the form-cutting unit 200, and the laying unit 900, both of the latter two, according to the invention, being operable from the vacuum gripper 800. The cutting-off unit 300 preferably has several holding apparatuses 400 which, with a respective lever apparatus 11, actuate a common clamping rail 12, preferably pneumatically, for the purpose of holding the lamination foil during the separating operation.

The pull-out unit 500 is further shown with several grippers 600 arranged on a beam 13. The beam 13 is movable in guide rails 10c and 10d in the X direction. Furthermore, FIG. 2 shows the form-cutter unit 200 which is arranged above the cutting table 700 and preferably comprises four cutting heads 14a-14d which are shown standing in one of the respective parking positions. The latter is advantageous to avoid collisions between the cutting heads 14a-14d.

The vacuum gripper 800 is shown in the laying position, however in this view the carrier plate and the transport system are not shown. The vacuum gripper 800 has two struts 15a and 15b which run with guide elements 16a and 16b in the guide rail 10b and with corresponding guide elements 16c and 16d in the guide rail 10a.

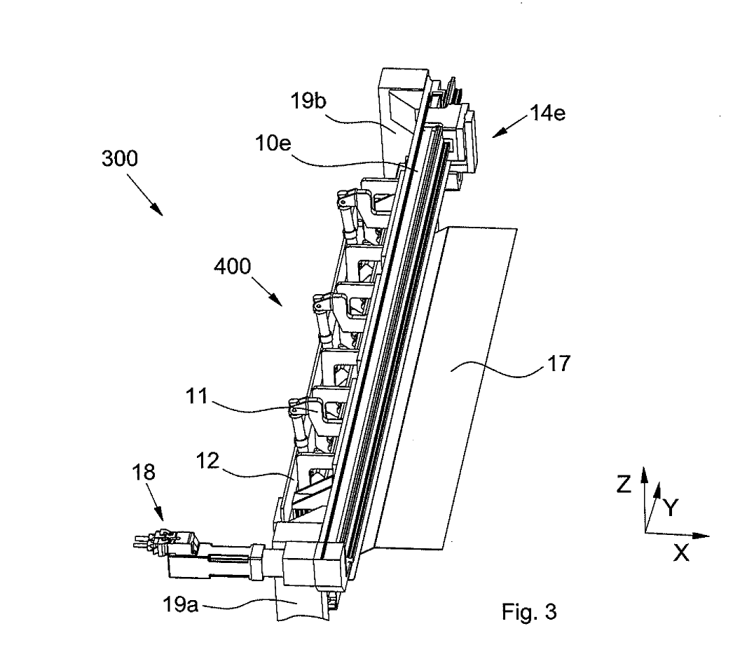

In FIG. 3 the cutting-off unit 300 is shown in detail. Arranged on two supports 19a and 19b is a guide rail 10e on which a cutting head 14e is movable in the Y direction, preferably motor-driven with a motor 18. The cutting head 14e can have a rotating cutting disk, a stationary or oscillating blade, or a laser. The lamination foil is guided through the cutting-off unit 300 from the left, and guided on its way by a guide plate 17. During the cutting-off operation by means of the cutting head 14e, the lamination foil is held simultaneously by the common clamping rail 12. The clamping rail 12 is operable by three holding apparatuses 400 that are shown with respective lever apparatus 11, preferably pneumatically operable.

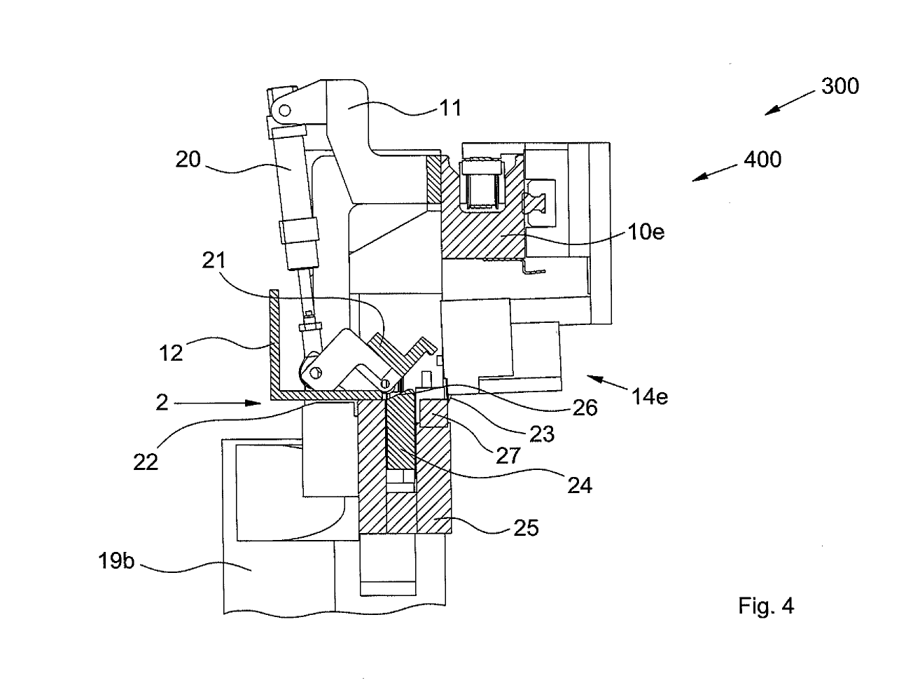

FIG. 4 shows the construction of the holding apparatus 400 in that a cut in the cutting-off unit 300 of FIG. 3 is laid between two holding apparatuses 400. For this purpose the gripping piece 12 and the guide rail 10e are shown hatched, also a press-down 21 and a push-up 24 which is embedded in a web 25. The web 25 runs, as also the guide rail 10e, between the supports 19a and 19b, of which in this cutaway representation only the support 19b is visible.

Also visible in FIG. 4 is that a piston 20 is arranged on the lever apparatus 11 which presses the clamping rail 12 down onto the lamination foil 2 which is passed through a guide aperture 22. The lamination foil 2 thus rests initially flat on a cutting beam 27 and can be cut off by a rotating cutting disk 23 of the cutting head 14e. On completion of the cut, the piston also actuates the press-down 21, which results in a beveling of the lamination foil 2 against the pressure of the push-up 24—or against an inclined end-face 26 of the push-up 24—which corresponds approximately to the angle of the end-face 26. The clamping rail 12 is independent of the press-down 21. This is necessary for the lamination foil 2 to be fixed when being bent upwards.

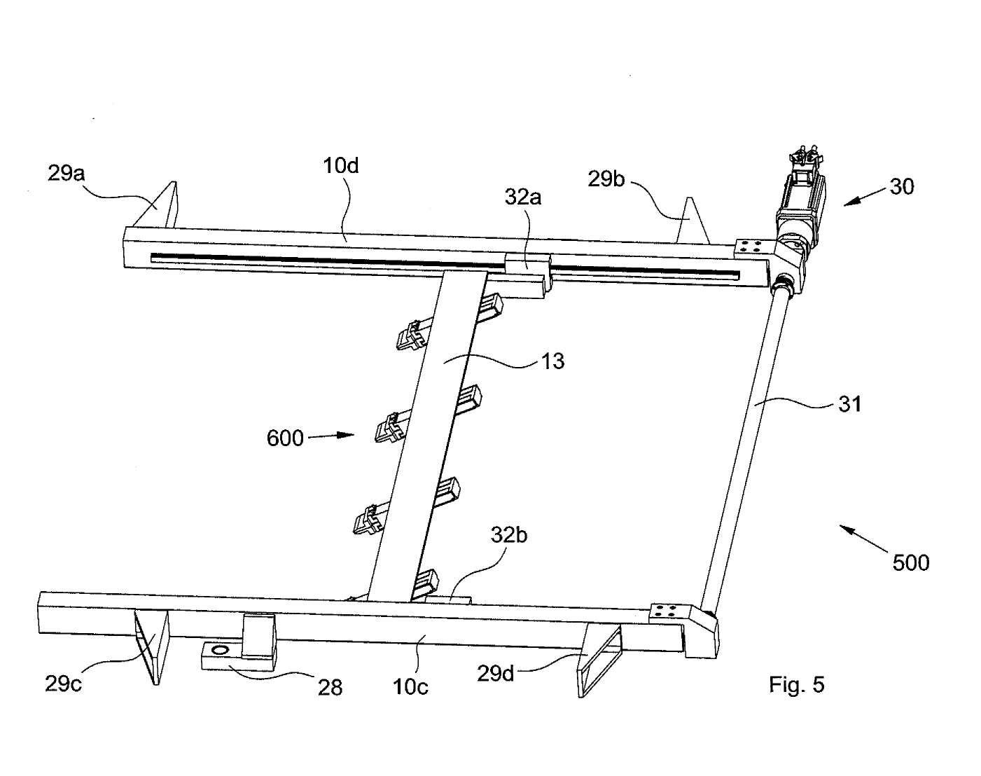

FIG. 5 shows the pull-out unit 500. Arranged on the beam 13 are, for example, four grippers 600 in an angle that corresponds to the beveling angle of the lamination foil described above. The angle is approximately 30 degrees. A drive 30 and a connecting shaft 31 ensure a synchronous displaceability of the beam 13 by means of a guide shoe 32a in the guide rail 10d and a corresponding guide shoe 32b in the guide rail 10c. The drive 30 is preferably embodied electric and a synchronous actuation of the gripper 600 pneumatic. The pull-out unit 500 also has a centering apparatus 28 and stops 29a-29d.

In the form shown, the pull-out unit 500 is embodied as a linear carriage unit. Under certain circumstances this can be disadvantageous in that, on completion of a pull-out motion, the gripper 600 must release the lamination foil again so as to then return in the opposite X direction into a starting position for the next piece of lamination foil. This return motion can, however, stand in the way of a further processing step in the form of a lowering of the vacuum gripper. For this reason, also disclosed here is a variant embodiment in which the pull-out unit 500 is returned to its starting position in circular- or oval-shaped guide rails 10c and 10d. Also to be included in this disclosure is a variant embodiment in which the gripper 600, on completed pull-out of the lamination foil, is pushed apart in the Y direction and a return path outside the action radius of the vacuum gripper is linearly described.

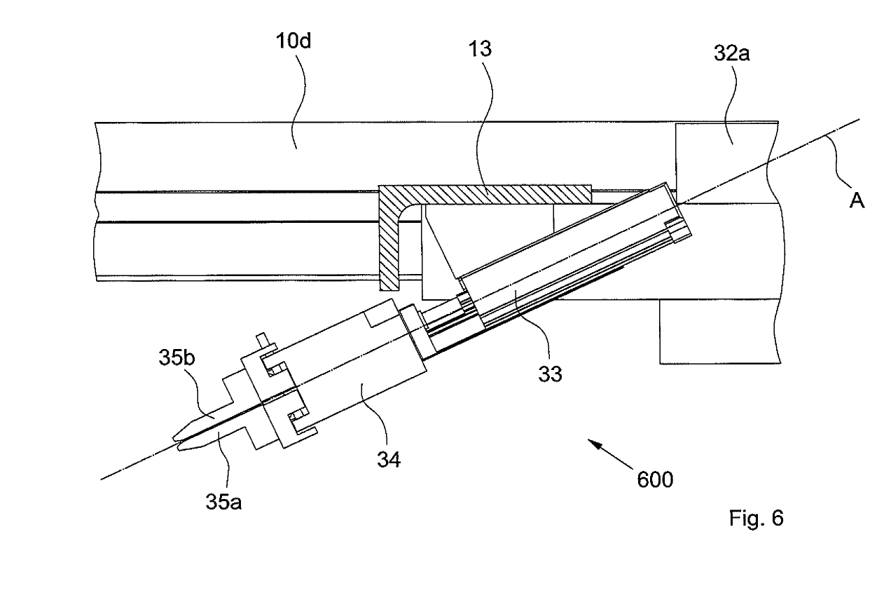

Shown in FIG. 6 is a gripper 600 according to the invention. It is arranged on the beam 13 in the said approximately 30-degree angle and has a preferably pneumatically operated carriage unit 33 by means of which the gripper 600 is displaceable along its longitudinal axis A. Arranged on a gripper head 34 are gripper jaws 35a and 35b which also preferably pneumatically can be opened and closed in mutually opposite directions.

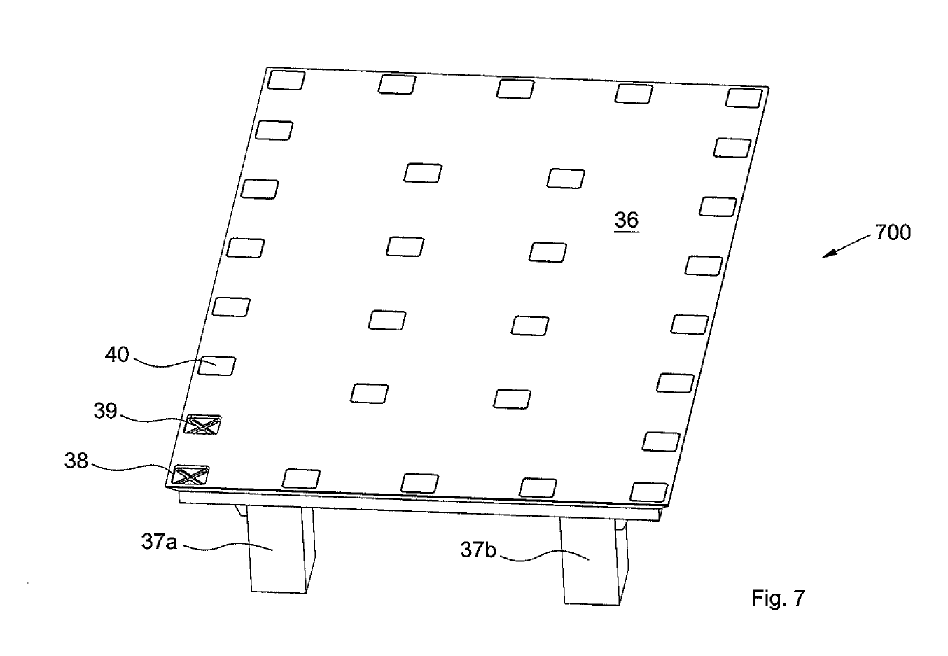

FIG. 7 shows the cutting table 700 according to the invention which contains a cutting-table plate 36. The latter stands on feet 37a and 37b which, in this perspective view, in contrast to two further symmetrically arranged, but concealed, feet, are visible. Embedded in the cutting-table plate 36 are recesses 38. These recesses 38 are provided with a suction channel 39 so that a sucker 40 that is inserted from above out of preferably porous material guarantees a slip-free laying of the lamination foil that has to be form-cut.

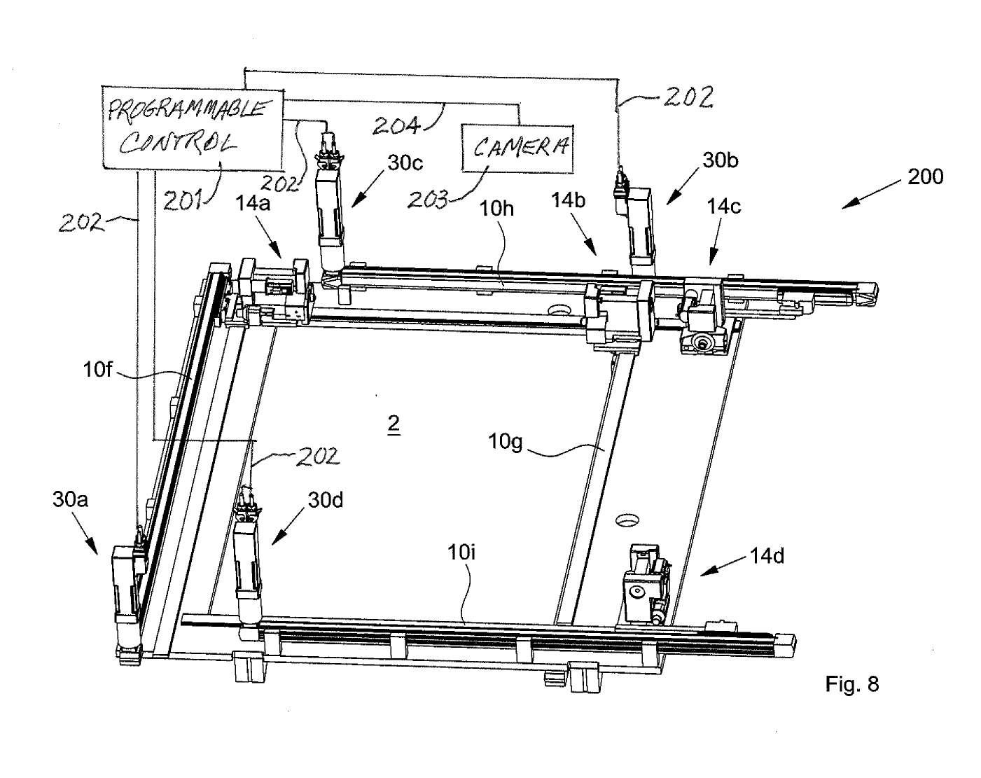

Shown in FIG. 8 is the form-cutter unit 200 according to the invention. The lamination foil 2 that rests on the here not visible cutting table is cut on its left side by the cutting head 14a, which is driven on a guide rail 10f by an electric drive 30a. The cutting head 14b cuts along a guide rail 10g, driven by an electric drive 30b; the cutting head 14c along a guide rail 10h, driven by an electric drive 30c; and the cutting head 14d, driven by an electric drive 30d, along a guide rail 10i.

Starting out from the parked position of the cutting heads 14a-14d, an, for example, simultaneous cut of all four cutting edges of the piece of lamination foil 2 is possible, when the cutting heads 14c and 14d start as soon as the cutting head 14b has released the path for the cutting head 14c, and the cutting heads 14c and 14d cut with a higher speed. This higher speed must, at least with regard to the possibility of a collision between the cutting heads 14b and 14c, be chosen in such manner that the cutting head 14c has completed its work before the cutting head 14b has returned to the shown parking position.

A cutting movement of the cutting heads 14a-14d is programmably controllable and wherein parking positions are allocatable to the cutting heads. A programmable control 201 exchanges movement control signals with the cutting heads 14a-14d over lines 202. Data information for the positions of the cutting heads 14a-14d is generated from a camera 203 and can be input into the programmable control 201 over a line 204.

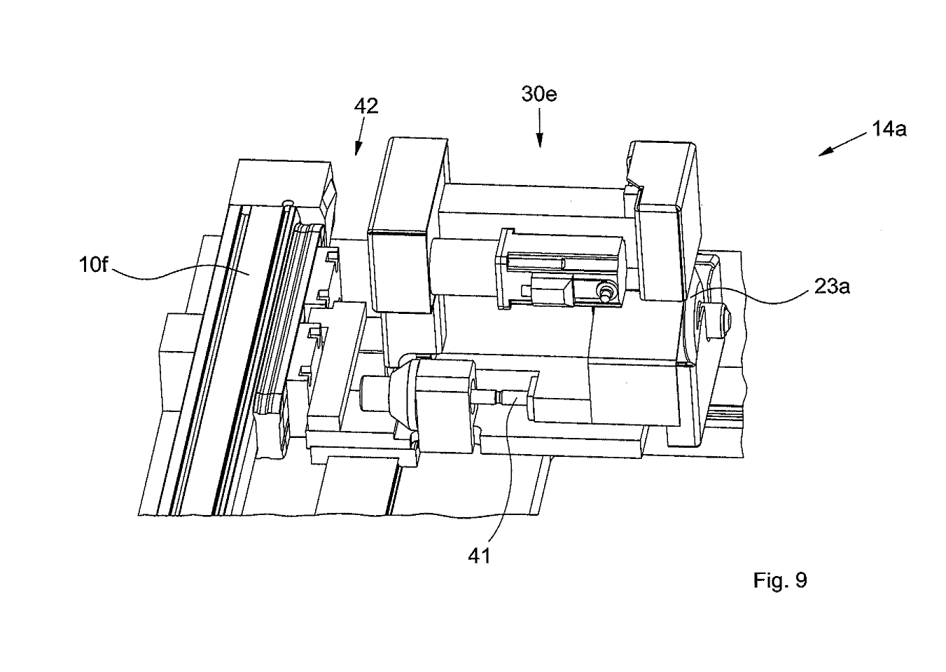

FIG. 9 shows the cutting head 14a in a detailed view. The cutting head 14a is arranged with a guide 42 on the guide rail 10f. It also has an own drive 30e, to drive a rotating cutting disk 23a, and a spindle 41, by means of which the rotating cutting disk 23a is displaceable.

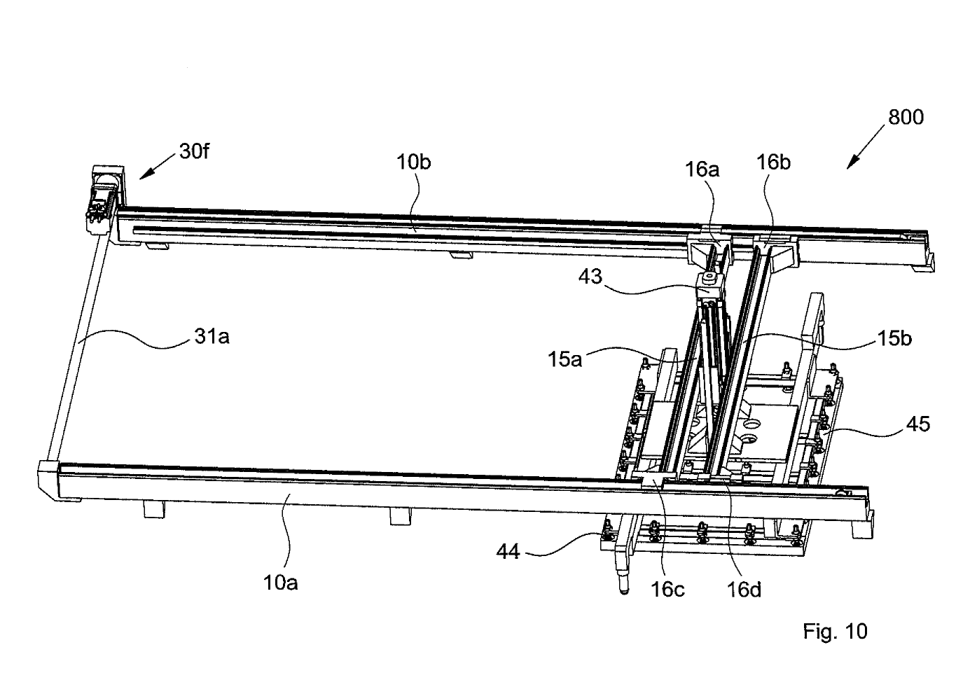

FIG. 10 shows the vacuum gripper 800 according to the invention, which essentially consists of the struts 15a and 15b, a gripper plate 45, and a pneumatic cylinder 43. With the pneumatic cylinder 43, a vertical displacement of the gripper plate 45 in the Z direction is provided. The gripper plate 45 has a plurality of suction cups 44, which suck the lamination foil onto the gripper plate. A drive 30f and a connecting shaft 31a make it possible for the vacuum gripper 800 to be movable synchronously with the guide elements 16a and 16b in the guide rail 10b, and with the guide elements 16c and 16d in the guide rail 10a, in the X direction.

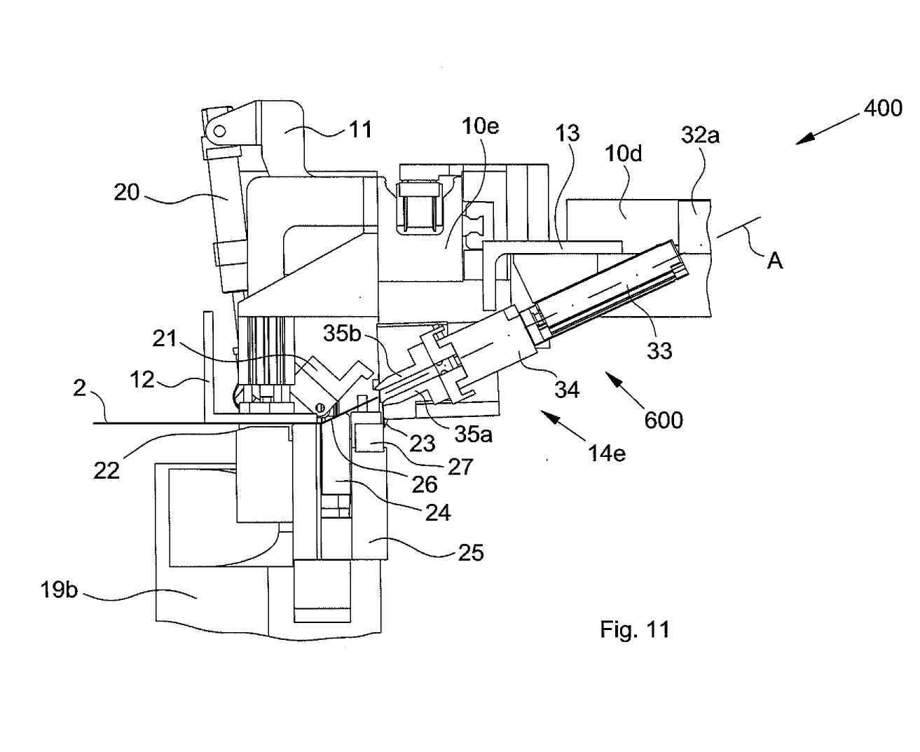

Shown in FIG. 11 is the holding apparatus 400 according to the invention, in cooperation with the gripper 600 according to the invention. The lamination foil 2 is cut off by the rotating cutting disk 23 and pushed by the push-up 24 into an accepting position for the gripper 600. The gripper 600 is now pushed, with opened gripper jaws 35a and 35b, with the aid of the carrier unit 33, along its lengthwise axis A over the pushed-up piece of lamination foil 2.

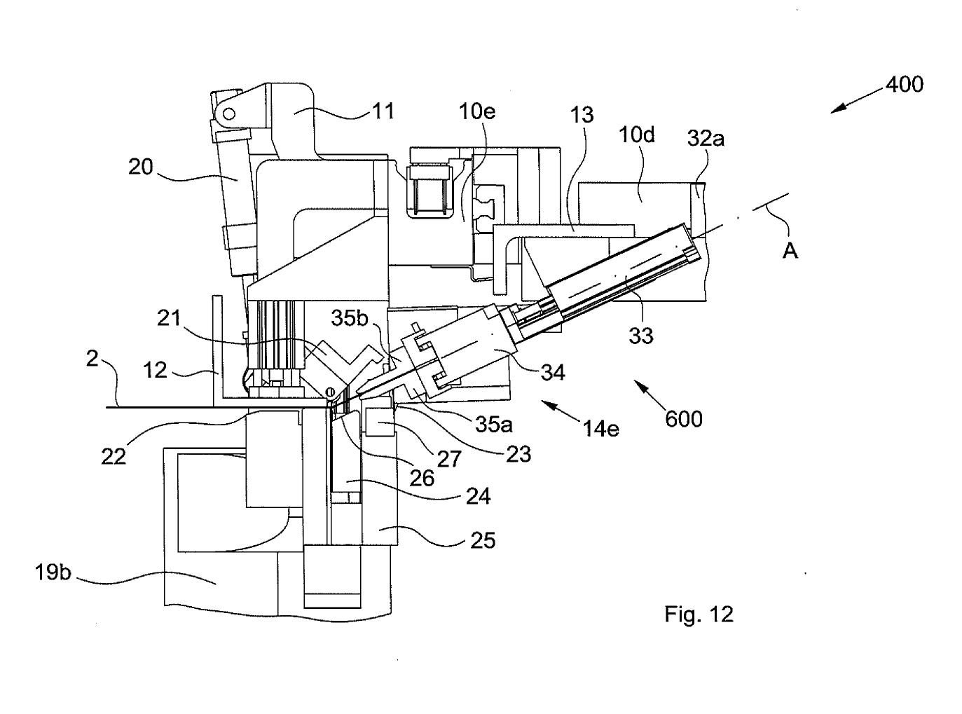

Shown in FIG. 12 is the step that follows after the situation illustrated in FIG. 11. The push-up 24 is retracted, and the gripper jaws 35a and 35b have grasped the lamination foil 2. A pull-out of the lamination foil 2 in horizontal X direction can now take place by the gripper 600, the beam 13, and the guide shoe 32a being moved horizontally on the guide rail 10d.

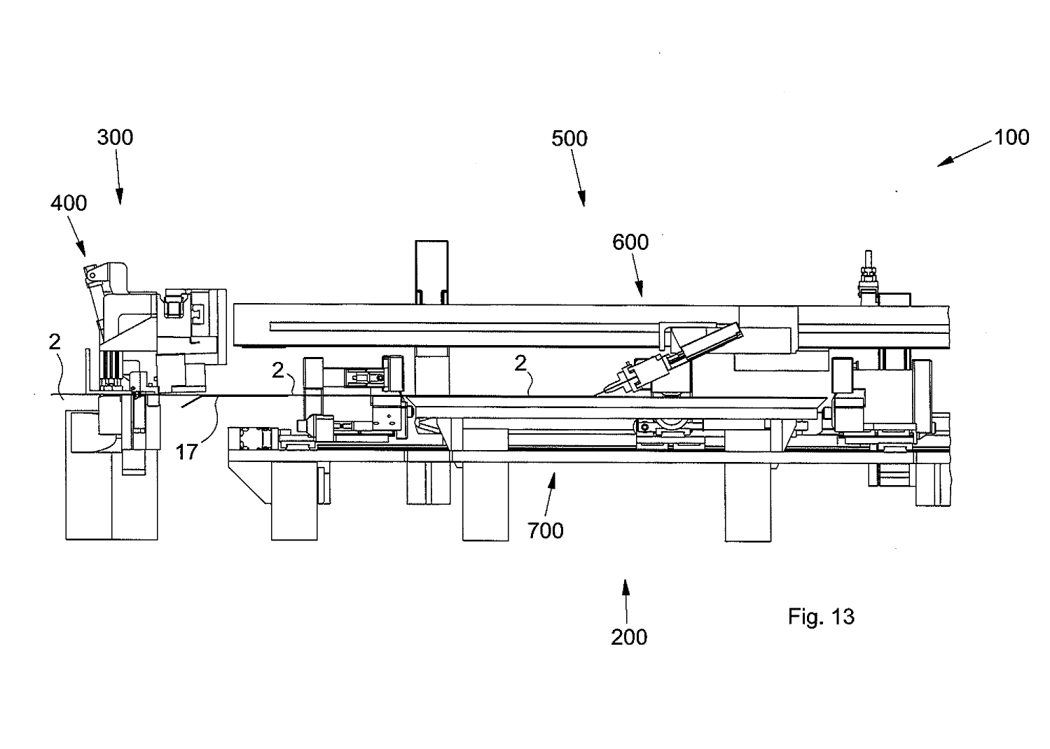

FIG. 13 shows the method step of pulling-out the lamination foil 2 onto the cutting table 700. As described in the preceding FIG. 12, the gripper 600 pulls the lamination foil 2 horizontally through the now opened holding apparatus 400, over the guide plate 17, and onto the cutting table 700, and has, in the position shown, traveled approximately half of the return path, which corresponds to a position in which the pull-out unit 500 must pause, and in which the cutting-off unit 300 must execute a further cut. In this manner, the piece of lamination foil 2 is so cut to length that it matches the width of the cutting table 700.

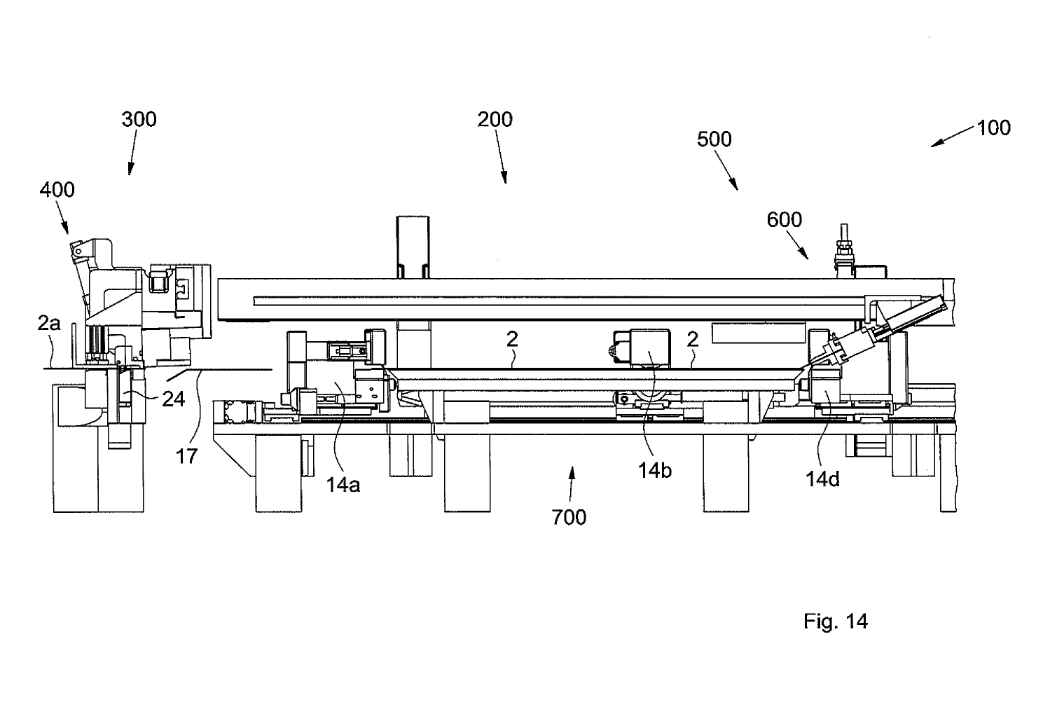

FIG. 14 shows the pull-out unit 500 and the gripper 600 in their respective end-positions. The piece of lamination foil 2 which is lying on the cutting table 700 is then sucked up, and in the cutting-off unit 300 a new piece of lamination foil 2a is ready to be bent upward by the push-up 24.

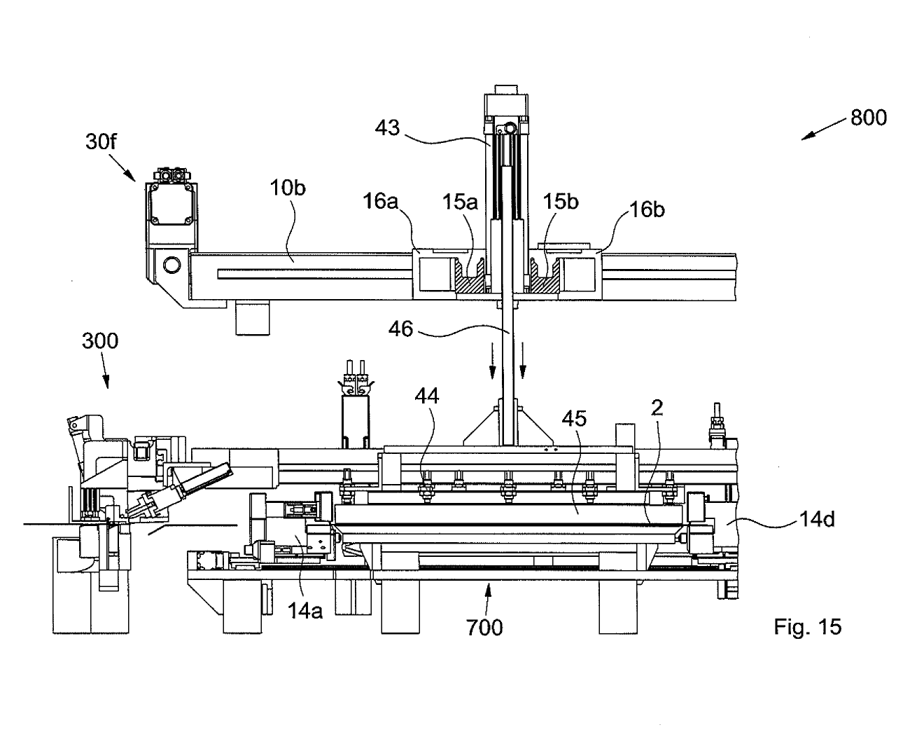

Shown in FIG. 15 is the next-following processing step, which is setting of the vacuum gripper 800 onto the lamination foil 2 that is lying on the cutting table 700. For this purpose, a piston rod 46 extends out of the pneumatic cylinder 43 and sets the gripper plate 45 with the suction cups 44 into the holding position of the piece of lamination foil 2 in which it will be form-cut in the following step. In this holding position, the piece of lamination foil 2 is held both by the—here not visible—suckers of the cutting table 700, and by the suction cups 44 of the vacuum gripper 800.

A further characteristic according to the invention which is not shown in more detail is a frame 45a which is arranged on the gripper plate 45 of the vacuum gripper 800. This frame 45a surrounds the external contour of the laying surface of the gripper plate 45, and has external dimensions which are approximately identical to the external dimensions of the laying surface of the cutting table 700. This frame 45a thus fulfils an additional holding function of the piece of lamination foil 2 which is flush and positionally accurate with the external edge of the cutting table 700.

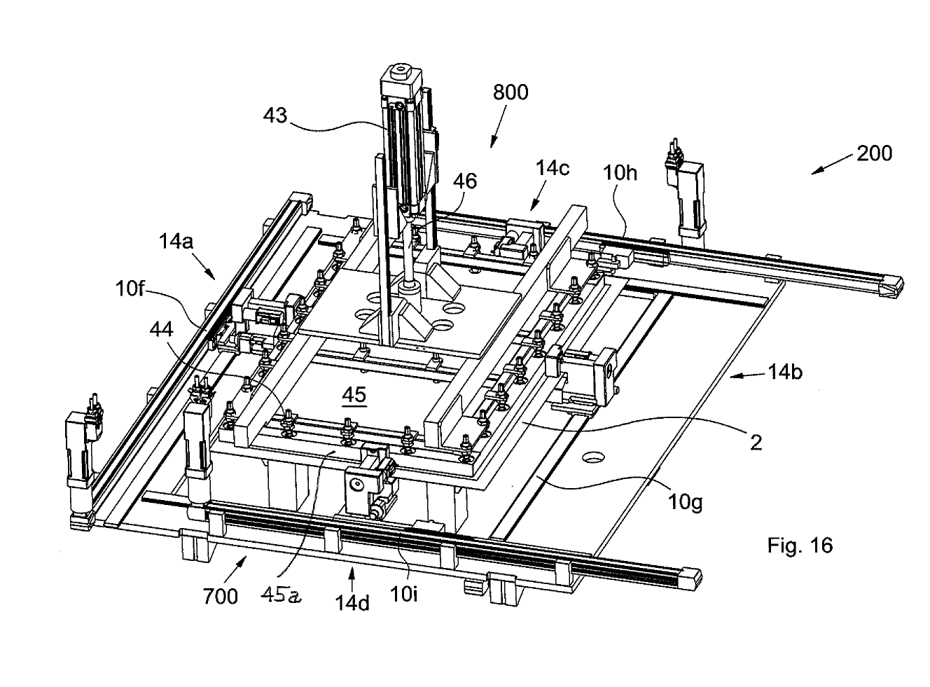

FIG. 16 shows the next-following processing step of the form-cutting of the piece of lamination foil 2 by the form-cutting unit 200. All four cutting heads 14a-14d are simultaneously in a cutting operation which proceeds, for example, as disclosed in the description to FIG. 8.

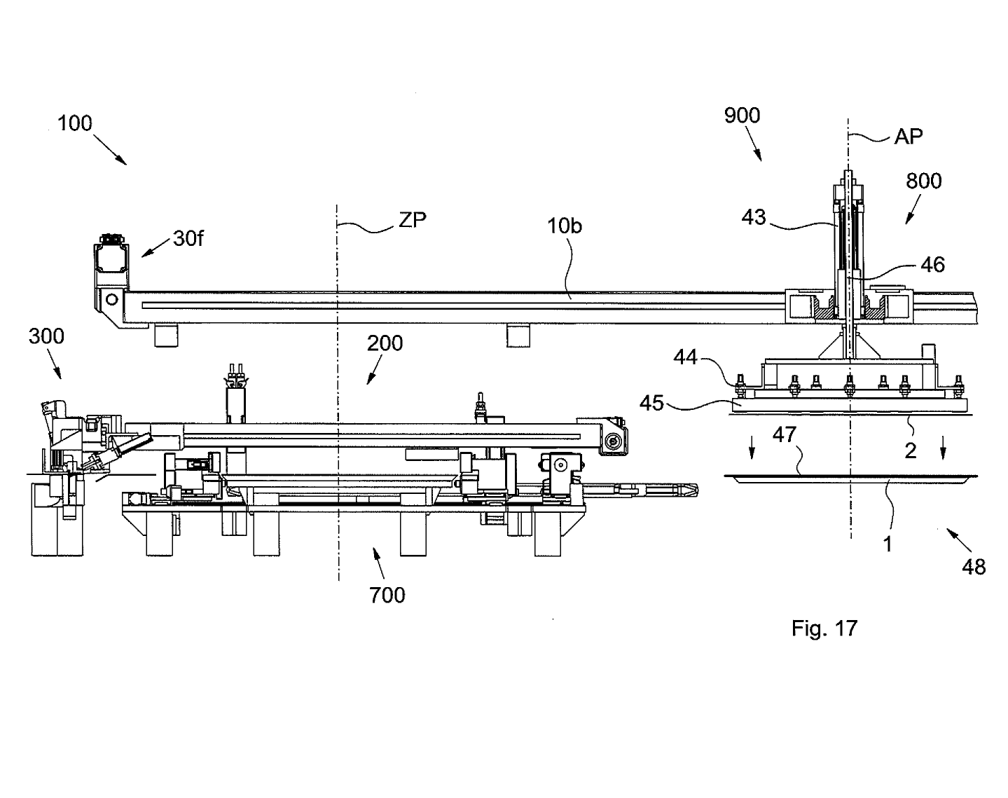

FIG. 17 shows that, after completed form-cutting of the piece of lamination foil 2, with simultaneous termination of the suction effect of the suckers 40 of the cutting table 700, which are here not shown in greater detail, the vacuum gripper 800 must lift the piece of lamination foil 2, which is still in the form-cutting position ZP, from the cutting table 700, first through an upward movement of the piston rod 46. The vacuum gripper 800 subsequently executes a horizontal movement along the guide rail 10b until it reaches the raised position AP above the carrier plate 1 with an applied sealing 47. Through a downward movement of the piston rod 46, the gripper plate 45, along with the completely form-cut and sucked-on lamination foil 2, is lowered, the suction effect of the suction cups 44 is terminated, or optionally replaced by application of an overpressure, and thus the piece of lamination foil 2 is laid positionally accurately onto the carrier plate 1. The piston rod 46 then executes a further upward movement, followed by a left-hand horizontal return movement of the vacuum gripper 800 along the guide rail 10b. Not shown in greater detail is the now following, and final, processing step of laying the cover plate 3 by means of the turnover module, see FIG. 1. After this processing step, a laminated solar module 48 is in the laying position AP, and ready for transporting away by the transport system 4b.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An apparatus for laminating a solar module, with a form-cutting unit for form-cutting lamination foil, with a cutting table to hold the lamination foil in a form-cutting position when form-cutting with at least one cutter, and with a laying unit, the laying unit comprising:
a gripper for holding the lamination foil in the form-cutting position on the cutting table when cutting; and
the laying unit being movable for traveling with a form-cut lamination foil piece into a laying position and laying the lamination foil piece onto a carrier plate in the laying position.

2. The apparatus according to claim 1 wherein the laying unit has a vacuum gripper which is movable on guide rails between the form-cutting position and the laying position.

3. The apparatus according to claim 2 including a frame arranged on a laying surface of said vacuum gripper, said frame which surrounds an external contour and having external dimensions approximately identical with external dimensions of a laying surface of the cutting table, and wherein the form-cutting unit executes a free cut along a cutting-table edge of the cutting table.

4. The apparatus according to claim 1 wherein the form-cutting unit includes four cutting heads which simultaneously cut the lamination foil piece from the lamination foil.

5. The apparatus according to claim 4 wherein a cutting movement of said cutting heads is programmably controllable and wherein parking positions are allocatable to said cutting heads.

6. The apparatus according to claim 5 wherein data information from a camera is input into a programmable control for controlling movement of the cutting heads.

7. The apparatus according to claim 4 wherein a cutter or a laser head of at least one of said cutting heads is displaceable with a spindle.

8. The apparatus according to claim 4 wherein said cutting heads of the form-cutting unit or guides for the cutting heads are integrated in side walls of the cutting table.

9. The apparatus according to claim 1 wherein the form-cutting unit includes one of cutters, a laser head and a stamping apparatus for rounding corners of the lamination foil piece, or cutting or stamping holes or recesses in the lamination foil piece.

10. The apparatus according to claim 1 including a pull-out unit which is movable in linear guide rails from an acceptance position of the lamination foil on a cutting-off unit to the form-cutting position on the cutting table.

11. The apparatus according to claim 1 wherein the cutting table has suction cups formed of porous material.

12. A method for lamination of a solar module comprising the following steps:
a. sucking a lamination foil onto a cutting-table plate of a cutting table;
b. using a traveling vacuum gripper to hold the lamination foil in a form-cutting position;
c. form-cutting the lamination foil to form a lamination foil piece;
d. terminating the suction effect on the cutting-table plate of the cutting table;
e. using the vacuum gripper to take the lamination foil piece out of the form-cutting position and into a laying position on a carrier plate;
f. lowering the vacuum gripper to lay the lamination foil piece onto the carrier plate; and
g. terminating the suction effect of the vacuum gripper.

13. The method according to claim 12 wherein the step of form-cutting is executed as simultaneous form-cutting of four edges of the lamination foil with four cutting heads.

14. The method according to claim 12 including first executing the following steps:
h. using a roller system to unroll the lamination foil from a foil unroller onto a laying surface;
i. using a holding apparatus of a cutting-off unit to hold the lamination foil on the laying surface;
j. using a cutting head of the cuffing-off unit to cut the lamination foil;
k. using grippers of a pull-out unit to grasp a cut edge of the lamination foil;
l. opening the holding apparatus of the cutting-off unit;
m. using the pulling-out unit to pull out the lamination foil onto the cutting table as far as a settable intermediate position;
n. closing the holding apparatus of the cutting-off unit;
o. cutting-off a piece of lamination foil by a further cut of the cutting head of the cutting-off unit;
p. opening the holding apparatus of the cutting-off unit; and
q. using the pulling-out unit to pull-out the piece of lamination foil until it is in an end-position on the cutting table.

15. The method according to claim 14 wherein before the step of grasping the cut edge of the lamination foil, executing the following steps:
r. beveling or pushing-up the cut edge of the lamination foil by an upwards motion of a push-up of the cutting-off unit; and
s. lowering of the push-up of the cutting-off unit.

16. The method according to claim 12 wherein form-cutting of the lamination foil takes place with a free cut along a cutting-table edge of the cutting table.

17. An apparatus for laminating a solar module including a carrier plate, comprising:
a form-cutting unit for form-cutting lamination foil and having a cutting table to hold the lamination foil in a form-cutting position when form-cutting with at least one cutter, and
a laying unit having a gripper for holding the lamination foil in the form-cutting position on said cutting table when cutting, said laying unit being movable for traveling with a lamination foil piece into a laying position and laying the lamination foil piece onto a carrier plate in the laying position.

18. The apparatus according to claim 17 wherein said form-cutting unit includes four cutting heads which simultaneously cut the lamination foil piece from the lamination foil.

19. The apparatus according to claim 17 including a pull-out unit which is movable in linear guide rails from an acceptance position of the lamination foil on a cutting-off unit to the form-cutting position on said cutting table.

20. The apparatus according to claim 17 wherein data information from a camera is input into a programmable control for controlling movement of said at least one cutting head.
